(19) United States
(12) Patent Application Publication
(10) Pub. No.: US 2009/0095073 A1
(43) Pub. Date: Apr. 16, 2009

(54) Impedance sensor

(75) Inventors: Kenji Fukumura, Kariya-city (JP); Tetsuo Yoshioka, Okazaki-city (JP); Takahiko Yoshida, Okazaki-city (JP)

Correspondence Address: POSZ LAW GROUP, PLC, 12040 SOUTH LAKES DRIVE, SUITE 101, RESTON, VA, 20191, US

(73) Assignee: DENSO CORPORATION, Kariya-city (JP)

(21) Appl. No.: 12/232,113

(22) Filed: Sep. 11, 2008

(30) Foreign Application Priority Data
Oct. 12, 2007 (JP) 2007-266418

(51) Int. Cl. G01N 27/22

(52) U.S. Cl. 73/335.04

(57) ABSTRACT

An impedance sensor for detecting a mixing ratio of a liquid or a gas includes a substrate, at least a pair of electrodes, and a protective film. The substrate is configured to be disposed in the liquid or the gas. The pair of electrodes is disposed on the substrate. The protective film is disposed on the substrate so as to cover the pair of electrodes. The protective film is made of a material having a relative permittivity greater than or equal to 6.

### CROSS REFERENCE TO RELATED APPLICATIONS

The present application is based on and claims priority to Japanese Patent Application No. 2007-266418 filed on Oct. 12, 2007, the contents of which are incorporated in their entirety herein by reference.

### BACKGROUND OF THE INVENTION

1. Field of the Invention

The present invention relates to an impedance sensor.

2. Description of the Related Art

Conventionally, an impedance sensor is used for detecting a mixing ratio of a liquid or a gas. For example, the impedance sensor can be used for detecting a mixing ratio of alcohol in a liquid fuel such as gasoline.

For example, JP-A-2005-201670 discloses an impedance sensor used as an alcohol concentration sensor. The alcohol concentration sensor detects a concentration of alcohol by detecting a capacitance in accordance with a relative permittivity of a measured object. The alcohol concentration sensor includes an insulating substrate, a pair of thin-film electrodes disposed on the insulating substrate, and an insulating protective film covering the pair of thin-film electrodes. Each of the insulating protective film and the insulating substrate is made of a material having a relative permittivity less than or equal to 5 so that the alcohol concentration sensor can detect the concentration of the alcohol with a high detection sensitivity.

However, according to a simulation performed by the inventor, a variation in the detection sensitivity of the alcohol concentration sensor may increase with a variation in the relative permittivity of the insulating protective film.

### SUMMARY OF THE INVENTION

In view of the foregoing problems, it is an object of the present invention to provide an impedance sensor.

According to an aspect of the invention, an impedance sensor for detecting a mixing ratio of a liquid or a gas includes a substrate, at least a pair of electrodes, and a protective film. The substrate is configured to be disposed in the liquid or the gas. The pair of electrodes is disposed on the substrate. The protective film is disposed on the substrate so as to cover the pair of electrodes. The protective film is made of a material having a relative permittivity greater than or equal to 6.

In the present impedance sensor, a variation in a detection sensitivity can be reduced and the detection sensitivity can be improved.

### BRIEF DESCRIPTION OF THE DRAWINGS

Additional objects and advantages of the present invention will be more readily apparent from the following detailed description of preferred embodiments when taken together with the accompanying drawings. In the drawings:

FIG. 1 is a cross-sectional view showing an impedance sensor according to an exemplary embodiment of the invention;

FIG. 2 is a top view showing the impedance sensor;

FIG. 3 is a graph showing a relationship between a mixing ratio of a liquid fuel and a capacitance;

FIG. 4A is a diagram showing parameters for simulating a relationship between a relative permittivity of a protective film and a detection sensitivity of the impedance sensor and FIG. 4B is a graph showing the simulated result;

FIG. 5A is a plan view showing a simulation analytical model, FIG. 5B is enlarged perspective view showing a part VB in FIG. 5A, and FIG. 5C is a cross-sectional view showing a part VC in FIG. 5B;

FIG. 6 is a graph showing a relationship between the relative permittivity of the protective film and a variation in the detection sensitivity of the impedance sensor when a thickness of the protective film is 0.1 μm;

FIG. 7A is a diagram showing parameters for simulating relationships among a thickness of the protective film, a width of teeth of electrodes, a distance between adjacent teeth of electrodes, and the detection sensitivity of the impedance sensor and FIG. 7B is a graph showing the relationships;

FIG. 8 is a graph showing the relationship between the distance of the electrodes and the detection sensitivity; and

FIG. 9 is a graph showing the relationship between the thickness of the protective film and the detection sensitivity of the impedance sensor when the variation in the thickness of the protective film is 0.05 μm.

### DETAILED DESCRIPTION OF THE PREFERRED EMBODIMENTS

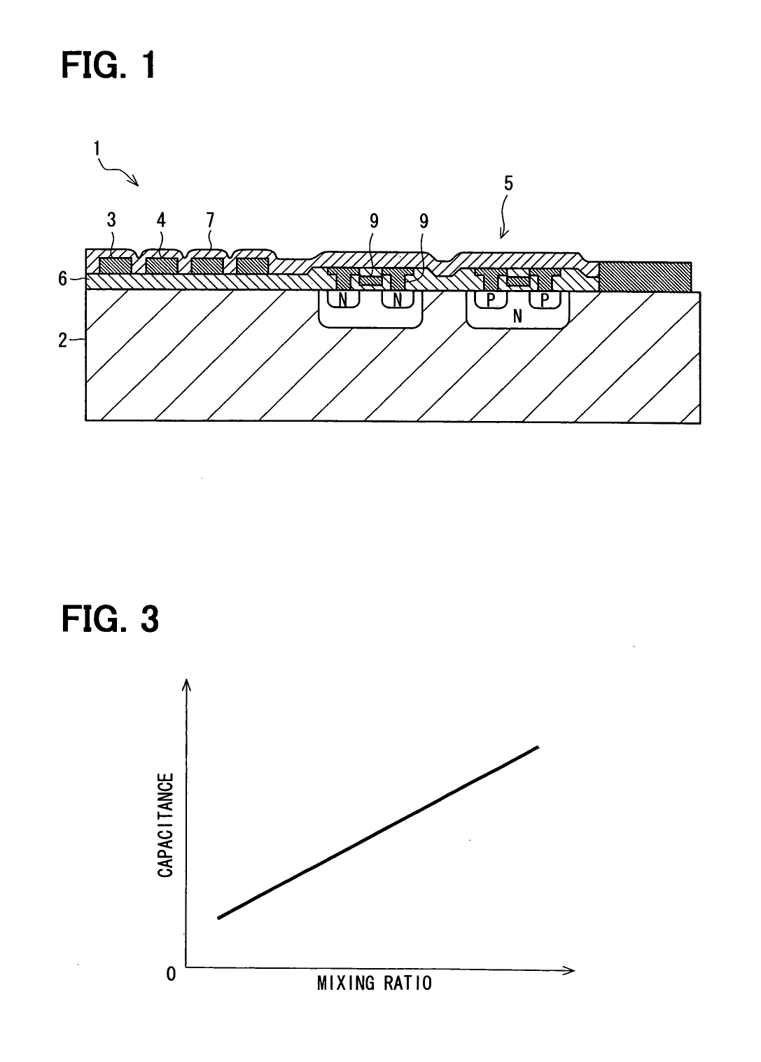

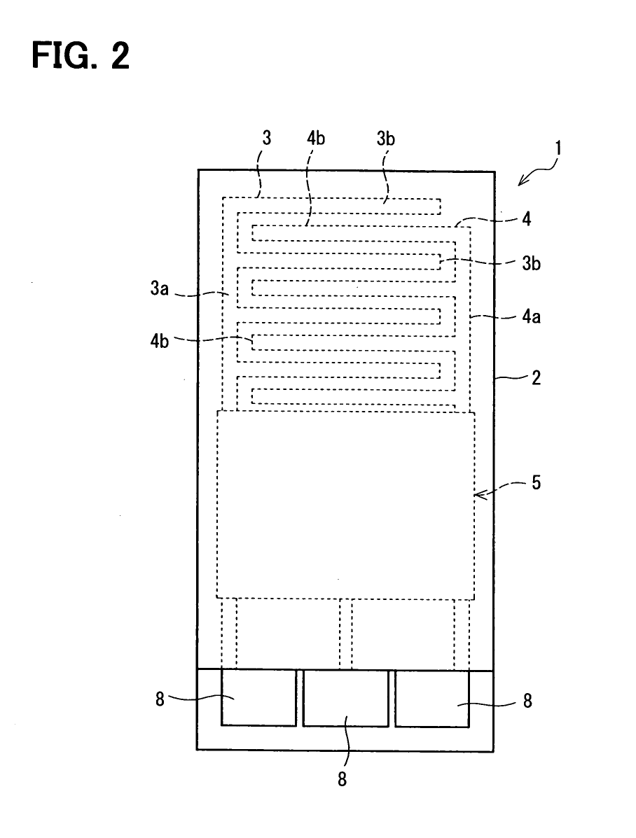

An impedance sensor 1 according to and exemplary embodiment of the invention will be described with reference to FIG. 1 and FIG. 2. The impedance sensor 1 can be suitably used for detecting a mixing ratio of alcohol in a liquid fuel, for example, gasoline.

The impedance sensor 1 includes a semiconductor substrate 2, electrodes 3 and 4, a signal processing circuit 5, an insulating layer 6, and a protective film 7. The semiconductor substrate 2 is made of silicon, for example. The insulating layer 6 is disposed on a surface of the semiconductor substrate 2, and the electrodes 3 and 4 are disposed on the insulating layer 6. The insulating layer 6 is made of silicon dioxide, for example. The surface of the semiconductor substrate 2 includes a first section and a second section. The electrodes 3 and 4 are arranged at the first section and the signal processing circuit 5 is arranged at the second section.

As shown in FIG. 2, each of the electrodes 3 and 4 has a comb shape. The electrode 3 includes a base portion 3a and a plurality of teeth 3b protruding from the base portion 3a. The electrode 4 also includes a base portion 4a and a plurality of teeth 4b protruding from the base portion 4a. The teeth 3b and the teeth 4b are alternately interposed so as to have a clearance between adjacent teeth. When the teeth 3b and the teeth 4b are alternately interposed, a dimension of each of the electrodes 3 and 4 can be reduced while increasing an opposing area of the electrodes 3 and 4.

The electrodes 3 and 4 are formed by attaching a metal material to a surface of the insulating layer 6, for example, by spattering, and forming a pattern by a photolithography process. For example, the metal material for the electrodes 3 and 4 is selected from aluminum, copper, titanium, platinum, gold, and tungsten. The electrodes 3 and 4 may also be made of a conductive non-metal material such as silicon and polysilicon.

The protective film 7 is made of an insulating material. The protective film 7 is disposed on the surface of the semiconductor substrate 2 so as to cover the electrodes 3 and 4 and the signal processing circuit 5. The protective film 7 is made of a material having a relative permittivity greater than or equal to 6. For example, the protective film 7 is made of silicon nitride or hafnium oxide (HfO2) having a high permittivity. The protective film 7 is deposited on the surface of the semiconductor substrate 2, for example, by plasma chemical vapor deposition (plasma CVD) or spattering, so as to have a uniform thickness. The protective film 7 has a sufficient tolerance so that the protective film 7 can be used in an environment having a strong corrosive, for example, in the liquid fuel. The protective film 7 can be formed easily by a conventional semiconductor manufacturing technique. The protective film 7 may be a single layer or a multilayer.

When the impedance sensor 1 is used for detecting the mixing ratio of the alcohol in the liquid fuel, a portion of the semiconductor substrate 2 including the electrodes 3 and 4 is soaked in the liquid fuel. A capacitance in accordance with the relative permittivity of the liquid fuel is stored between the teeth 3b of the electrode 3 and the teeth 4b of the electrode 4. Thereby, the impedance sensor 1 can detect a change in the capacitance in accordance with the capacitance of the liquid fuel. In the present example, the impedance sensor 1 includes a pair of electrodes, i.e., the electrode 3 and the electrode 4, as an example. Alternatively, the impedance sensor 1 may include a plurality of pairs of electrodes. In a case where the impedance sensor 1 includes two pairs of electrodes having different dimension, one pair can be used as a reference. In the present example, each of the electrodes 3 and 4 has a comb shape, as an example. The electrodes 3 and 4 may have other shape.

The impedance sensor 1 further includes three pads 8 disposed on the surface of the semiconductor substrate 2. For example, the three pads 8 are arranged at an opposite side of the electrodes 3 and 4 with respect to the signal processing circuit 5. The three pads 8 and the electrodes 3 and 4 are coupled with the signal processing circuit 5. The signal processing circuit 5 includes a filter circuit and an amplifier circuit constituted by electronic elements such as a complementary metal-oxide semiconductor transistor (CMOS transistor) and a capacitor. The signal processing circuit 5 further includes a processing circuit that detects a temperature of a measured object (e.g., liquid fuel) and adjusts a relationship between the mixing ratio and the capacitance in accordance with the temperature. The signal processing circuit 5 outputs a signal to an external device through one of the pads 8. Another one of the pads 8 is a ground pad and the other one of the pads 8 is a power pad. As shown in FIG. 1, the signal processing circuit 5 includes the insulating layer 6, a wiring layer 9, and the protective film 7. The number of pads 8 may also be greater than three.

When the impedance sensor 1 is used for detecting the mixing ratio of the alcohol included in the liquid fuel (e.g., gasoline), the impedance sensor 1 is housed in a sensor case in such a manner that the electrodes 3 and 4 are exposed to an outside of the sensor case. Thereby, the electrodes 3 and 4 are soaked in the liquid fuel and the other portion of the impedance sensor 1 is restricted from coming in contact with the liquid fuel.

The relationship between the mixing ratio and the capacitance of the liquid fuel including the gasoline and the alcohol is examined in advance and a graph illustrating the relationship, as shown in FIG. 3, is stored in the signal processing circuit 5. The signal processing circuit 5 can calculate the mixing ratio corresponding to the detected capacitance based on the graph. The relative permittivity of the liquid fuel including the gasoline and the alcohol changes with a temperature. Thus, the signal processing circuit 5 stores the relationship between the mixing ratio and the capacitance at each temperature and adjusts the detected result in accordance with detected temperature of the liquid fuel.

The impedance sensor 1 may measure impedance that includes a dielectric loss in addition to the capacitance. By measuring a plurality of physical quantities at a time, the impedance sensor 1 can detect the mixing ratio with a high degree of accuracy. In addition, the impedance sensor 1 can determine whether a foreign material is mixed with the liquid fuel and the impedance sensor 1 can adjust error.

A detection sensitivity of the impedance sensor 1 is affected by a plurality of parameters including a thickness of the protective film 7, a relative permittivity of the protective film 7, a thickness of the insulating layer 6, a relative permittivity of the insulating layer 6, a thickness of electrodes 3 and 4, a distance between the adjacent teeth 3b and 4b, and a relative permittivity of the semiconductor substrate 2. The inventors focus on the relative permittivity of the protective film 7 that has a great effect on the detection sensitivity. According to experimental productions and a simulation by the inventors, when the protective film 7 is made of a material having a relative permittivity greater than or equal to 6, for example, silicon nitride or silicon dioxide, the detection sensitivity of the impedance sensor 1 can be improved compared with a case where the protective film 7 is made of a material having the relative permittivity less than 6. When the relative permittivity of the protective film 7 is greater than or equal to 6, an electric field concentrates on the measured object side more than the semiconductor substrate side. According to Gauss' low expressed by formula (1), the relative permittivity is an index expressing a weakness in the electric field due to a polarization of a dielectric substance.

∇·E=ρ/ε (1)

In formula (1), “E” is an electric field, “ρ” is a volume density of charge, and “ε” is a permittivity of a dielectric substance. When the electric field weakens, a voltage per unit charge between the electrodes 3 and 4 decreases. Thus, when the same voltage is applied to the electrodes 3 and 4, the amount of charge stored between the electrodes 3 and 4 increases. That is, when the relative permittivity between the electrodes 3 and 4 increases, the capacitance increases. As a result, when the relative permittivity increases, the impedance sensor 1 can detect the capacitance of the measured object with a high degree of accuracy.

For example, when the mixing ratio of the alcohol in the liquid fuel is detected from the capacitance, a difference between a capacitance of 100% gasoline and a capacitance of 100% alcohol is defined as a detection sensitivity. When the difference between the capacitance of 100% gasoline and the capacitance of 100% alcohol increases, the impedance sensor 1 can detect the mixing ratio with a high degree of accuracy.

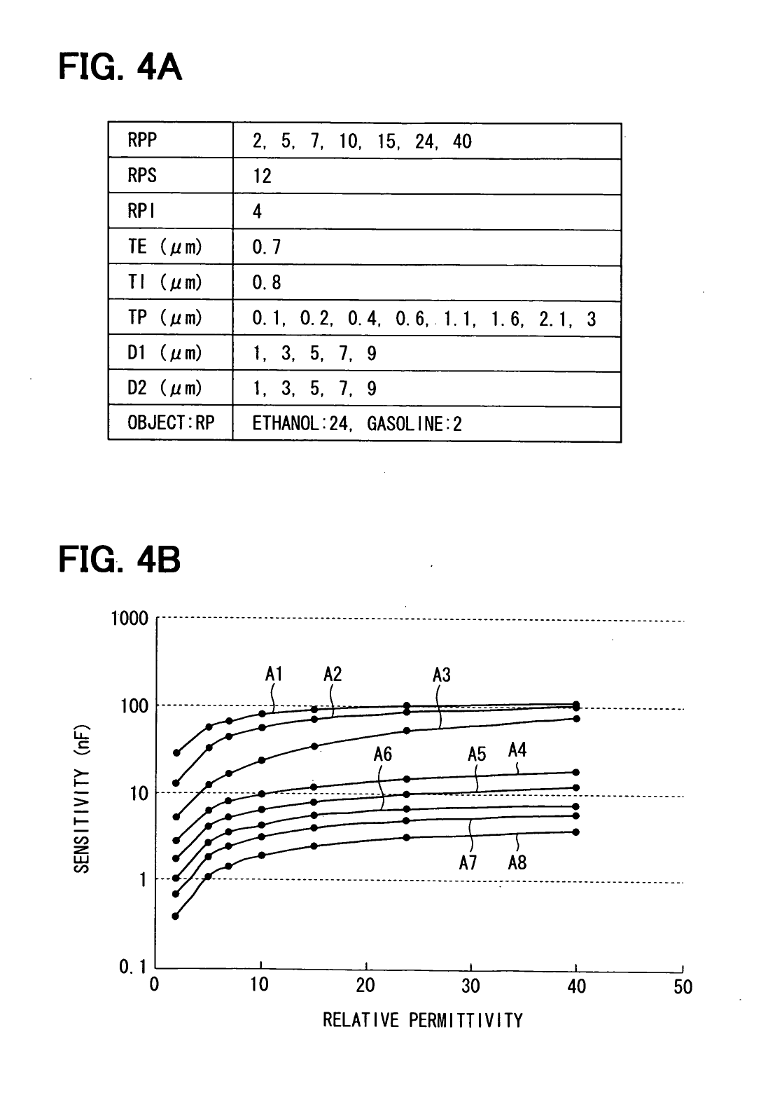

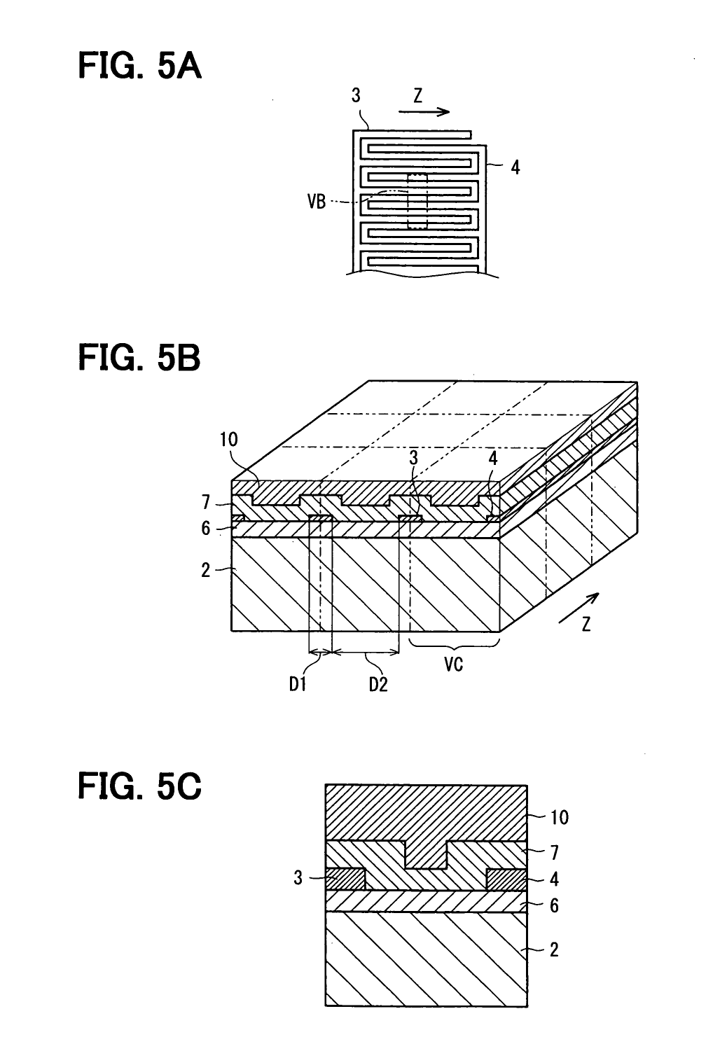

The capacitance of 100% gasoline and the capacitance of 100% alcohol can be detected between the electrodes 3 and 4 by using an analytical model shown in FIG. 5A-FIG. 5C, and the difference between the capacitances, i.e., the detection sensitivity of the impedance sensor 1 can be calculated, as was demonstrated by the inventors. An object of the present simulation is only a pair of teeth 3b and 4b of the electrodes 3 and 4, as shown in FIG. 5C. Each of the teeth 3b and 4b has a length of 1 mm in a Z-axis direction. The electrodes 3 and 4 are soaked in the measured object, i.e., the gasoline and the alcohol. The simulation is performed with parameters shown in FIG. 4A.

The relative permittivity of the protective film 7 (RPP) is set to 2, 5, 7, 10, 15, 24, and 40. The relative permittivity of the semiconductor substrate 2 (RPS) is fixed at 12. The relative permittivity of the insulating layer 6 (RPI) is fixed at 4. The thickness of the electrodes 3 and 4 (TE) is fixed at 0.7 μm, and the thickness of the insulating layer 6 (TI) is fixed at 0.8 μm. The thickness of the protective film 7 (TP) is set to 0.1 μm, 0.2 μm, 0.4 μm, 0.6 μm, 1.1 μm, 1.6 μm, 2.1 μm, and 3 μm. A width of each of the teeth 3b and 4b shown by distance D1 in FIG. 5B is set to 1 μm, 3 μm, 5 μm, 7 μm, and 9 μm. A distance between adjacent teeth 3b and 4b shown by distance D2 in FIG. 5B is set to 1 μm, 3 μm, 5 μm, 7 μm, and 9 μm.

In FIG. 4B, the solid line Al shows the simulated result when the thickness of the protective film 7 is 0.1 μm. The solid line A2 shows the simulated result when the thickness of the protective film 7 is 0.2 μm. The solid line A3 shows the simulated result when the thickness of the protective film 7 is 0.4 μm. The solid line A4 shows the simulated result when the thickness of the protective film 7 is 0.6 μm. The solid line A5 shows the simulated result when the thickness of the protective film 7 is 1.1 μm. The solid line A6 shows the simulated result when the thickness of the protective film 7 is 1.6 μm. The solid line A7 shows the simulated result when the thickness of the protective film 7 is 2.1 μm. The solid line A8 shows the simulated result when the thickness of the protective film 7 is 3 μm.

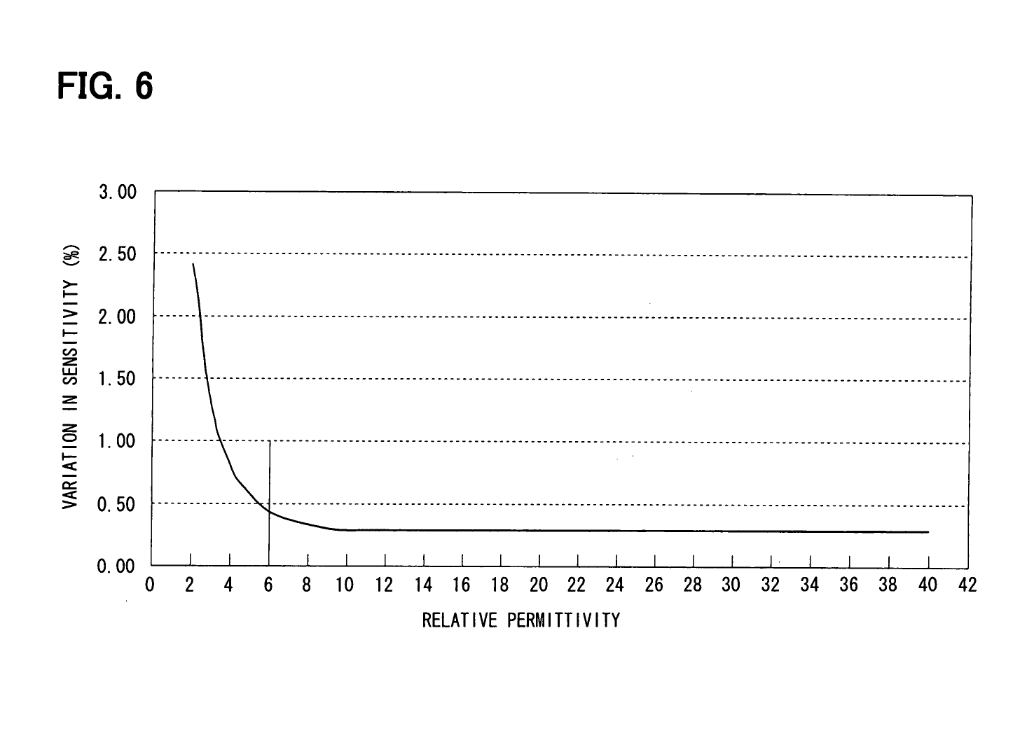

As shown in FIG. 4B, when the relative permittivity of the protective film 7 is greater than or equal to 6, the impedance sensor 1 can have a high detection sensitivity compared with a case where the relative permittivity of the protective film 7 is less than 6. In addition, as shown in FIG. 6, when the relative permittivity of the protective film 7 is greater than or equal to 6, a variation in the detection sensitivity of the impedance sensor 1 can be kept within about 0.5% regardless of the thickness of the protective film 7, even if a manufacturing variation in the relative permittivity of the protective film 7 is about ±0.5. Although FIG. 6 shows the variation in the detection sensitivity in a case where the thickness of the protective film 7 is 0.1 μm, the variation in the detection sensitivity shows similar tendency even if the thickness of the protective film 7 changes.

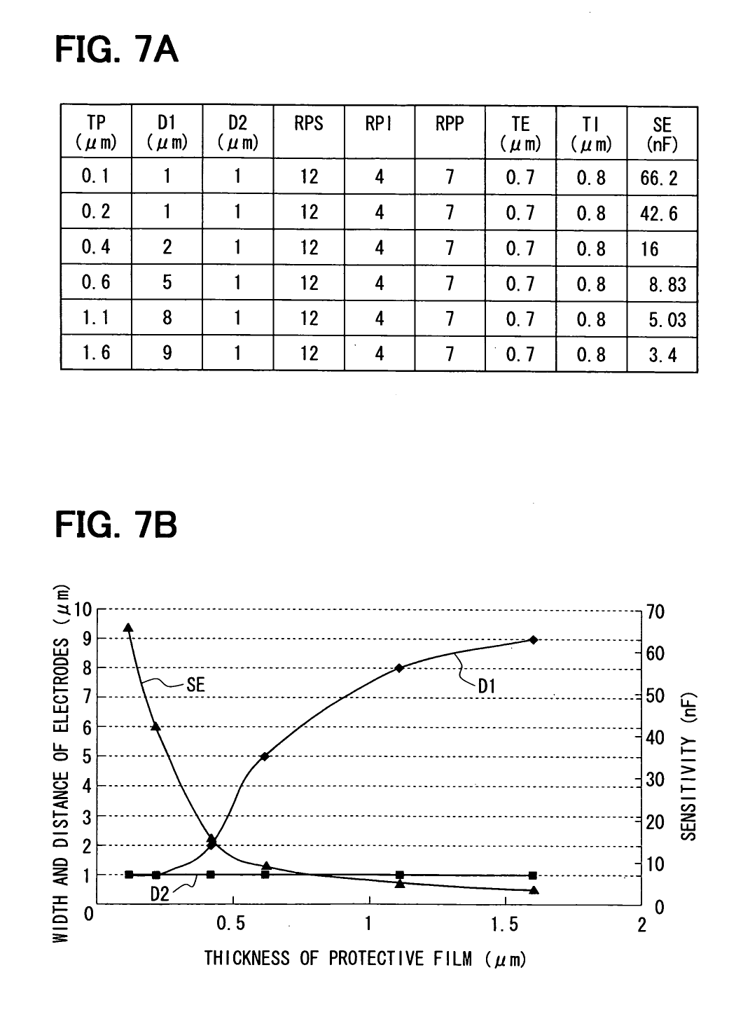

As shown in FIG. 4B, by increasing the relative permittivity of the protective film 7, the detection sensitivity of the impedance sensor 1 increases and the variation in the detection sensitivity is reduced. A simulation for investigating relationships among the thickness of the protective film 7, the width of the teeth 3b and 4b of the electrodes 3 and 4, the distance between the adjacent teeth 3b and 4b of the electrodes 3 and 4, and the detection sensitivity of the impedance sensor 1 can be performed as was demonstrated by the inventors. The present simulation is performed by using the analytical model shown in FIG. 5A-FIG. 5C with parameters shown in FIG. 7A. The simulation result is shown in FIG. 7B.

As shown in FIG. 7A, the thickness of the protective film 7 (TP) is set to 0.1 μm, 0.2 μm, 0.4 μm, 0.6 μm, 1.1 μm, and 1.6 μm. The width of each of the teeth 3b and 4b of the electrodes 3 and 4 (D1) is set to 1 μm, 1 μm, 2 μm, 5 μm, 8 μm, and 9 μm. The distance between the adjacent teeth 3b and 4b of the electrodes 3 and 4 (D2) is fixed at 1 μm. The relative permittivity of the semiconductor substrate 2 (RPS) is fixed at 12. The relative permittivity of the insulating layer 6 (RPI) is fixed at 4. The thickness of each of the electrodes 3 and 4 (TE) is fixed at 0.7 μm. The thickness of the insulating layer 6 is fixed at 0.8 μm.

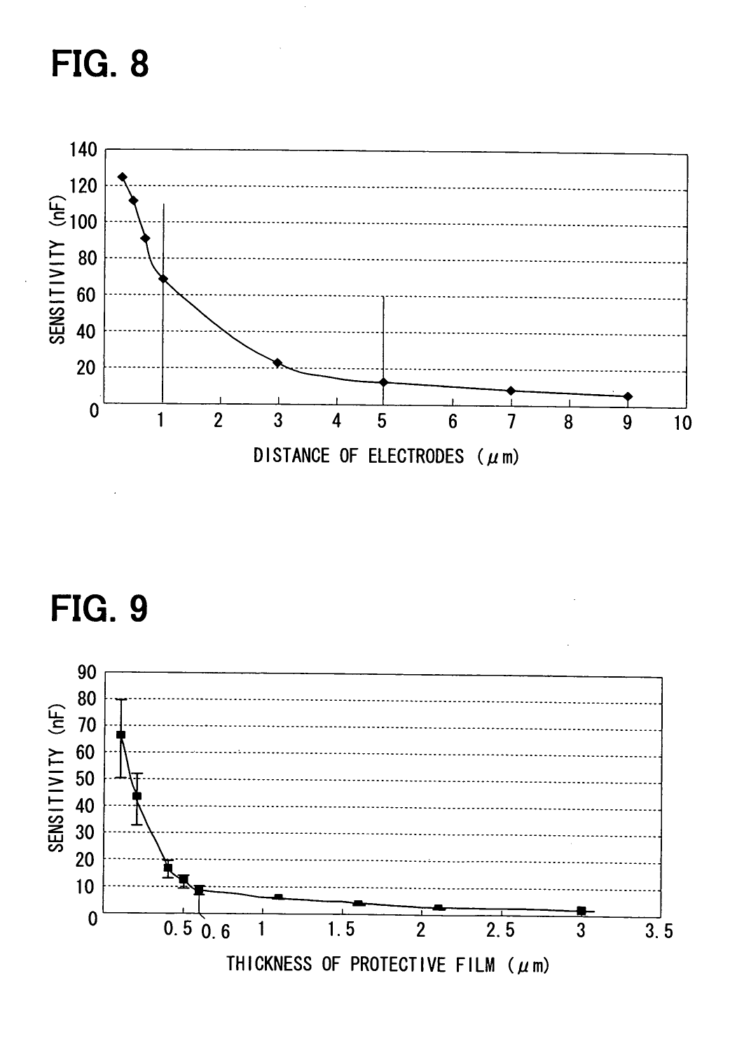

As shown in FIG. 8, when the distance between the adjacent teeth 3b and 4b of the electrodes 3 and 4 is less than or equal to about 5 μm, the impedance sensor 1 can have a high detection sensitivity compared with a case where the distance between the adjacent teeth 3b and 4b is greater than 5 μm. When the distance between the adjacent teeth 3b and 4b is 1 μm, the difference between the capacitance of the gasoline and the capacitance of the alcohol increases, and thereby the detection sensitivity of the impedance sensor 1 further increases. By reducing the distance between the adjacent teeth 3b and 4b, the electric field provided between the electrodes 3 and 4 increases. As a result, the impedance sensor 1 can detect a large change in the capacitance. According to the Gauss' low,

C=εᵣ×ε₀×s/d (2)

In formula (2), “C” is a capacitance, “εᵣ” is a relative permittivity of the measured object, “ε₀” is a relative permittivity of vacuum, “s” is an area of electrodes and “d” is a distance between the electrodes. Thus, by reducing the distance between the adjacent teeth 3b and 4b of the electrodes 3 and 4, the detection sensitivity of the impedance sensor 1 increases.

As shown in FIG. 9, in a case where the variation in the thickness of the protective film 7 is 0.05 μm, when the thickness of the protective film 7 is greater than or equal to 0.6 μm, the variation in the detection sensitivity can be kept within 10% although the absolute value of the detection sensitivity decreases.

In contrast, when the thickness of the protective film 7 is less than 0.6 μm, the impedance sensor 1 can have a high detection sensitivity, and thereby a process of the detected signal becomes easy. In addition, a dimension of a detecting element can be reduced.

In the present impedance sensor 1, the protective film 7 is disposed on the surface of the semiconductor substrate 2 so as to cover the electrodes 3 and 4. The protective film 7 directly contacts the electrodes 3 and 4 and is interposed between the electrodes 3 and 4, i.e., between the teeth 3b and 4b. The relative permittivity of the protective film 7 is greater than or equal to 6. Thus, the variation in the detection sensitivity can be reduced and the detection accuracy can be improved. When the protective film 7 is made of a material having a high permittivity, for example, a material having a relative permittivity of 40, the detection sensitivity further increases, as shown in FIG. 4B.

In addition, when the distance between the adjacent teeth 3b and 4b of the electrodes 3 and 4 is less than or equal to 1 μm, an electric field provided between the electrodes 3 and 4 becomes strong. In the present case, when the thickness of the protective film 7 is set to be greater than or equal to 0.6 μm, the variation in the detection sensitivity can be reduced although the detection sensitivity decreases. When the thickness of the protective film 7 is less than 0.6 μm, the detection sensitivity increases and the process of the detected signal becomes easy.

When the relative permittivity of the protective film 7 is set, the relative permittivity of the protective film 7 can be increased by adding substance such as phosphorous and boron into a material that constitutes the protective film 7, for example, silicon nitride or silicon dioxide. By adding the substance, the protective film 7 can have a predetermined permittivity. Furthermore, because the protective film 7 can be made of silicon nitride or silicon dioxide, a production cost of the impedance sensor 1 can be reduced.

In addition, because the impedance sensor 1 is small, the impedance sensor 1 can be disposed in a fuel passage of a motor. Thus, the impedance sensor 1 can directly detect the mixing ratio of the alcohol in the liquid fuel with a high degree of accuracy.

What is claimed is:

1. An impedance sensor for detecting a mixing ratio of a liquid or a gas, comprising:
a substrate configured to be disposed in the liquid or the gas;
at least a pair of electrodes disposed on the substrate;
a protective film disposed on the substrate so as to cover the pair of electrodes, wherein
the protective film is made of a material having a relative permittivity greater than or equal to 6.

2. The impedance sensor according to claim 1, wherein:
one of the electrodes is located at a predetermined distance from the other one of the electrodes; and
the predetermined distance is less than or equal to 5 μm.

3. The impedance sensor according to claim 2, wherein
the predetermined distance is less than or equal to 1 μm.

4. The impedance sensor according to claim 2, wherein
the protective film has a thickness greater than or equal to 0.6 μm.

5. The impedance sensor according to claim 1, wherein:
each of the pair of electrodes has a comb shape including a base portion and a plurality of teeth protruding from the base portion;
the teeth of one of the electrodes and the teeth of the other one of the electrodes are alternately interposed so as to have a predetermined distance between adjacent teeth; and
the predetermined distance is less than or equal to 5 μm.

6. The impedance sensor according to claim 5, wherein
the predetermined distance is less than or equal to 1 μm.

7. The impedance sensor according to claim 5, wherein
the protective film has a thickness greater than or equal to 0.6 μm.

8. The impedance sensor according to claim 5, wherein:
the protective film directly contacts the pair of electrodes; and
the protective film is interposed between the pair of electrodes.

9. The impedance sensor according to claim 1, wherein
the substrate is configured to be disposed in a fuel passage of a motor.

10. The impedance sensor according to claim 1, wherein
the liquid is an alcohol in a liquid fuel.
